(19) United States
(12) Patent Application Publication
(10) Pub. No.: US 2025/0191030 A1
(43) Pub. Date: Jun. 12, 2025

(54) SYSTEM AND METHOD FOR DELIVERING CUSTOMIZED PROMOTIONS TO REDUCE CHURN OF TELEVISION USERS

(71) Applicant: DISH Network L.L.C., Englewood, CO (US)

(72) Inventors: Dmitry Dimov, San Francisco, CA (US); Anastasiia Zhiboedova, San Francisco, CA (US); Junji Wiener, Golden, CO (US)

(21) Appl. No.: 18/535,696

(22) Filed: Dec. 11, 2023

(51) Int. Cl. G06Q 30/0251; H04N 21/2668

(52) U.S. Cl. CPC G06Q 30/0269; H04N 21/2668

(57) ABSTRACT

Described herein embodiments for customizing promotional packages to users of a subscription-based service based on their probabilities of churn. An exemplary method includes extracting, using one or more machine learning models, a set of features from a data storage of the subscription-based service for each user of a plurality of users of the subscription-based service; and classifying, using a machine learning model, the plurality of users into a plurality of types of users based on their respective sets of features; determining, using a machine learning model, a favorite channel for each of the plurality of users based on a subset of their respective sets of features; and displaying a targeted message on the determined favorite channel for each user of the plurality of users on a presentation device of the respective user, wherein users in each type of the plurality of types of users share the same targeted message.

### TECHNICAL FIELD

The present disclosure relates generally to user retention within television services, and more specifically relates to leveraging machine learning models to identify groups of users with different probabilities of churn and then tailor promotional messages based on the probabilities of churn.

### BRIEF SUMMARY

Television service providers, both in the realm of traditional broadcasting and in newer digital streaming platforms, consistently face the challenge of user attrition, commonly referred to as churn. Churn represents a significant loss in revenue and poses challenges in maintaining consistent growth for these providers. Traditional approaches to addressing churn are either reactive, where service providers reach out to users only after they have terminated their services or expressed intent to do so; or rely on churn prediction models that are based on basic heuristics such as user viewing patterns, payment behaviors, or direct feedback. These churn prediction models provide a narrow window into the multifaceted factors driving a user's decision to discontinue a service. In addition, subsequent promotional countermeasures based on these traditional prediction models, such as broad-based discounts or universal content recommendations, are often generic in nature and run the risk of being economically inefficient: they may underserve subscribers with a high probability of churn, providing insufficient incentives to retain them, while potentially overcompensating those with a lower churn propensity, resulting in unnecessary costs.

Described herein are systems, methods, and media for customizing promotional packages to users of a subscription-based service (e.g., Sling TV) based on their probabilities of churn and delivering customized promotional messages to users via their respective preferred channels. In one embodiment, a method of delivering targeted messages to users of a subscription-based service includes extracting, using one or more feature extraction machine learning models, a set of features from a data storage of the subscription-based service for each user of a plurality of users of the subscription-based service; and classifying, using a user classification machine learning model, the plurality of users into a plurality of types of users based on their respective sets of features, wherein each type of the plurality of types of users is associated with a range of probability values. The method further includes determining, using a favorite channel determination machine learning model, a favorite channel for each of the plurality of users based on a subset of their respective sets of features; and displaying a targeted message on the determined favorite channel for each user of the plurality of users on a presentation device of the respective user, wherein users in each type of the plurality of types of users share the same targeted message.

In some embodiments of the method, the target message for each type of users is a promotional message with a promotional value that is inversely proportional to an upper limit of the associated range of probability values.

In some embodiments of the method, the set of features for each of the plurality of users includes one or more of: a user watching pattern; user watching pattern changes; a recording pattern; payment consistency; commitment nearness; signal strength; demographics; or recency, frequency, money (RFM) data.

In some embodiments of the method, the presentation device of the respective user is one of: a television, a personal computer, or a smart phone.

In some embodiments of the method, the subset of features for each user of the plurality of users includes one or more of: a user watching pattern, user watching pattern changes, or a recording pattern.

In some embodiments of the method, each of the one or more feature extraction machine learning models, the user classification machine learning model, and the favorite channel determination machine learning model is a tree based learning model. In other alternative non-limiting example embodiments, the user classification machine learning model, and the favorite channel determination machine learning model may be a deep learning model.

In some embodiments of the method, the user classification machine learning model is a tree based learning model that uses a distributed gradient-boosting framework for machine learning. For example, such models may use or include light gradient-boosting machine (LightGBM), which is a free and open-source distributed gradient-boosting framework for machine learning, originally developed by Microsoft®. LightGBM is based on decision tree algorithms and used for ranking, classification and other machine learning tasks. As another example, such models may include or use Extreme Gradient Boosting (XGBoost). XGBoost is an open-source software library which provides a regularizing gradient boosting framework for C++, Java, Python, R, Julia, Perl, and Scala. XGBoost is a scalable, portable and distributed gradient boosting library. In other alternative non-limiting example embodiments, the user classification machine learning model may be a convolutional neural network (CNN) model that is trained based training data obtained using the Synthetic Minority Over-sampling Technique (SMOTE).

In some embodiments of the method, the extracting of the set of features from the data storage of the subscription-based service for each user of a plurality of users is performed by a plurality of parallel processing nodes, wherein each of the one or more feature extraction machine learning models runs one of the plurality of parallel processing nodes.

In an embodiment, each deep learning model described in various embodiments of the disclosure can be executed by multiple computing nodes in parallel. Further, all the data (e.g., user data, account data) may be loaded into a distributed shared memory (DSM) to be accessed by the multiple parallel processing nodes, thus enhancing the system's scalability since it allows more processing nodes to be added as more processing power is needed.

According to other embodiments, the methods can be implemented by a system and/or a computer readable storage medium as described herein.

As shown above and in more detail throughout the disclosure, various embodiments of the disclosure provide technical improvements over existing systems for managing streaming devices. These and other features and advantages of the disclosure will become more readily apparent in view of the embodiments described herein and illustrated in this specification.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 is an overview block diagram illustrating an example content distribution environment in which embodiments of the disclosure may be implemented.

FIG. 2 is a block diagram illustrating a system for delivering targeted messages to users that are determined to have different probabilities of chum according to an embodiment of the disclosure.

FIG. 3 is a block diagram further illustrating the feature engineering component 203 according to an embodiment of the disclosure.

FIG. 4 is a block diagram further illustrating the user classifier according to an embodiment of the disclosure.

FIG. 5 is a block diagram further illustrating the user favorite channel identifier 209 according to an embodiment of the disclosure.

FIG. 6 is a block diagram illustrating a system for delivering a targeted message to a presentation device 607 of a user via the user's favorite channel according to an embodiment of the disclosure.

FIG. 7 is a block diagram illustration a process of delivering targeted messages to users of a subscription-based service according to an embodiment of the disclosure.

FIG. 8 shows a system diagram that describes an example implementation of a computing system(s) for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments can be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments can be methods, systems, media, or devices. Accordingly, the various embodiments can be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “In some embodiments of the method,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

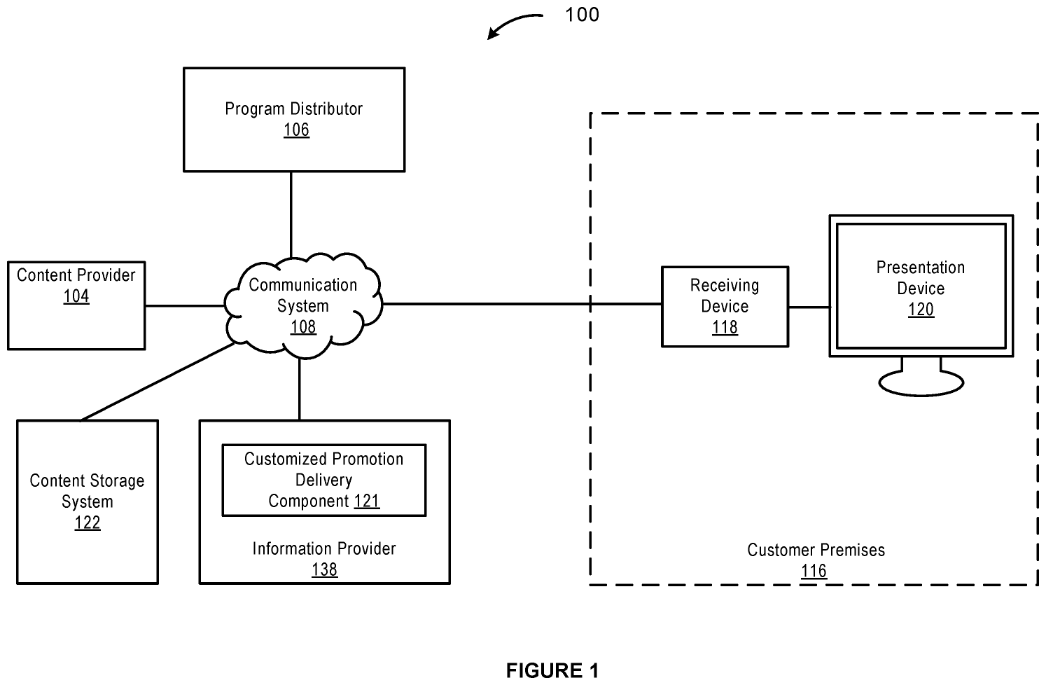

FIG. 1 is an overview block diagram illustrating an example content distribution environment 100 in which embodiments of the disclosure may be implemented. In the content distribution environment 100, audio, video, and/or data service providers, such as television service providers, provide their customers with a multitude of video and/or data programming (hereafter, collectively and/or exclusively “programming”). Such programming is often provided by use of a receiving device 118 communicatively coupled to a presentation device 120 configured to receive the programming.

The receiving device 118 interconnects to one or more communications media or sources. For example, the various media content may be delivered as data using the Internet protocol (IP) suite over a packet-switched network such as the Internet or other packet-switched network. The underlying connection carrying such data may be via a cable head-end, satellite antenna, telephone company switch, cellular telephone system, Ethernet portal, off-air antenna, or the like. The receiving device 118 may receive a plurality of programming by way of the communications media or sources or may only receive programming via a particular channel or source described in greater detail below. In some embodiments of the method, based upon selection by a user, the receiving device 118 processes and communicates the selected programming to the presentation device 120. Also, In some embodiments of the method, the presentation device 120 may also be a receiving device 118 or have a receiving device 118 integrated within it.

For convenience, examples of a receiving device 118 may include, but are not limited to devices such as, or any combination of: a “television converter,” “receiver,” “set-top box,” “television receiving device,” “television receiver,” “television,” “television recording device,” “satellite set-top box,” “satellite receiver,” “cable set-top box,” “cable receiver,” “media player,” “digital video recorder (DVR),” “digital versatile disk (DVD) Player,” “computer,” “mobile device,” “tablet computer,” “smart phone,” “MP3 Player,” “handheld computer,” and/or “television tuner,” etc. Accordingly, the receiving device 118 may be any suitable converter device or electronic equipment that is operable to receive or playback programming. Further, the receiving device 118 may itself include user interface devices, such as buttons or switches.

Examples of a presentation device 120 may include, but are not limited to, one or a combination of the following: a television (“TV”), a personal computer (“PC”), a sound system receiver, a digital video recorder (“DVR”), a compact disk (“CD”) device, DVD Player, game system, tablet device, smart phone, mobile device or other computing device or media player, and the like. The presentation devices 120 employ a display, one or more speakers, and/or other output devices to communicate video and/or audio content to a user. In many implementations, one or more presentation devices 120 reside in or near a customer's premises 116 and are communicatively coupled, directly or indirectly, to the receiving device 118. Further, the receiving device 118 and the presentation device 120 may be integrated into a single device. Such a single device may have the above-described functionality of the receiving device 118 and the presentation device 120 or may even have additional functionality.

A content provider 104 provides program content, such as television content, to a distributor, such as the program distributor 106. Example content providers include television stations which provide local or national television programming and special content providers which provide premium based programming, pay-per-view programming, and on-demand programming.

Program content (i.e., a program including or not including advertisements) is communicated to the program distributor 106 from the content provider 104 through suitable communication media, generally illustrated as a communication system 108 for convenience. The communication system 108 may include many different types of communication media including those utilized by various different physical and logical channels of communication.

In at least one embodiment, the received program content is converted by the program distributor 106 into a suitable signal (a “program signal”) that is communicated to the receiving device 118. Various embodiments of the receiving device 118 may instead receive programming from program distributors 106 and/or directly from content providers 104 via locally broadcast RF signals, cable, fiber optic, Internet media, or the like via the communication system 108, such as from the content storage system 122.

In addition, information provider 138 may provide various forms of content and/or services to various devices residing in the customer premises 116. For example, Information provider 138 may also provide information to the receiving device 118 regarding insertion of advertisement or other additional content or metadata into a media content segment provided to the receiving device 118. In some embodiments of the method, such advertisements or other additional content or metadata may be provided by an advertisement server to the content provider 104, directly to the receiving device 118 or be inserted into the streaming media stored on the content storage system 122 or as it is being streamed to the receiving device 118.

As shown, the information provider 138 includes a customized promotion delivery component 121, which is configured to extracting, using one or more machine learning models, a set of features from a data storage of the subscription-based service for each user of a plurality of users of the subscription-based service; classify, using a machine learning model, the plurality of users into a plurality of types of users based on their respective sets of features; and determine, using a machine learning model, a favorite channel for each of the plurality of users based on a subset of their respective sets of features.

The above description of the content distribution environment 100, the customer premises 116, and the various devices therein, is intended as a broad, non-limiting overview of an example environment in which various embodiments of securely providing adaptive bit rate streaming media content on-demand may be implemented. FIG. 1 illustrates just one example of a content distribution environment 100 and the various embodiments discussed herein are not limited to such environments. In particular, content distribution environment 100 and the various devices therein, may contain other devices, systems and/or media not specifically described herein.

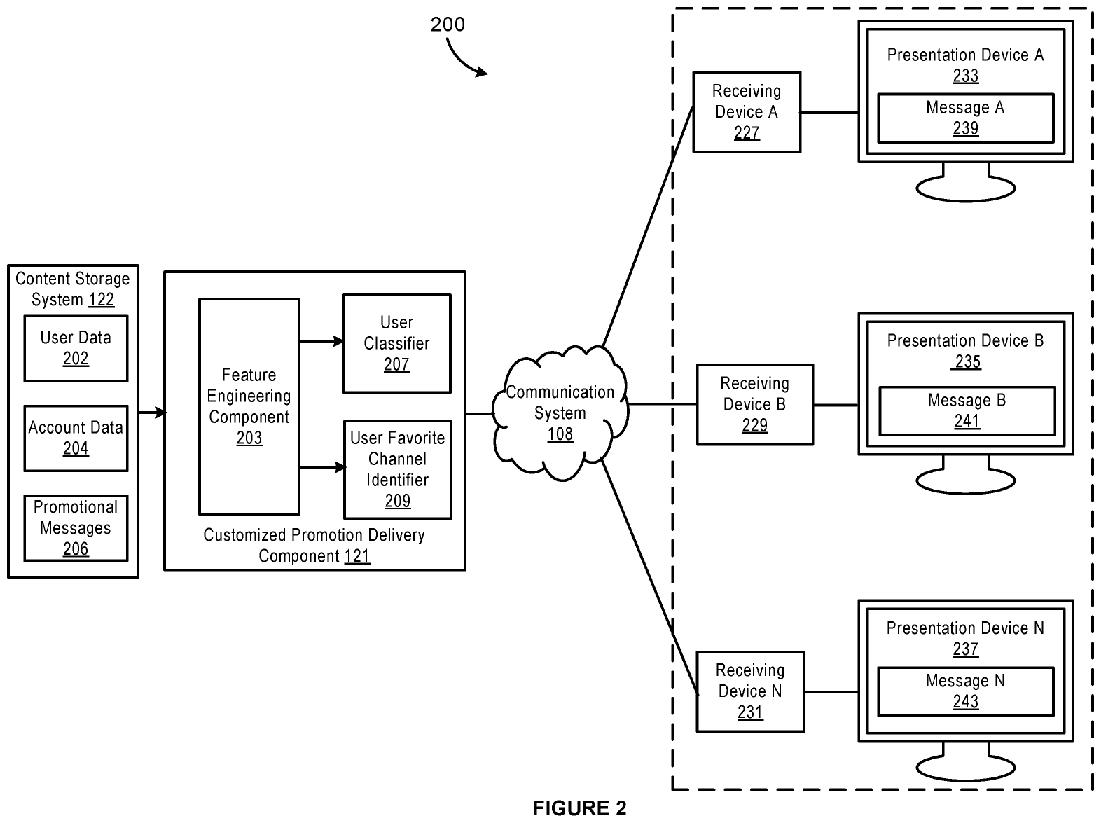

FIG. 2 is a block diagram illustrating a system 200 for delivering targeted messages to users that are determined to have different probabilities of churn according to an embodiment of the disclosure. The system 200 can be implemented in the content distribution environment 100.

As shown, the customized promotion delivery component 121 can further includes a feature engineering component 203, a user classifier 207, and a user favorite channel identifier 209.

The feature engineering component 203 can prepare input for the user classifier 207, and the user favorite channel identifier 209 by extracting features from the content storage system 122, which can include user data 202 and account data 204 for all users of the system. The users can be subscribers of one or more services provided by the content distribution environment 100.

The feature engineering component 203 uses a variety of machine learning techniques, such as natural language processing and feature selection, to extract features from the content storage system 122. The feature engineering component 203 can be trained on a large dataset of user data 202 and account data 204. The training data allows the component to learn how to identify and extract features as specified by model trainers. These extracted features can then be fed into the user classifier 207 and the user favorite channel identifier 209 to predict user churn and identify user favorite channels.

The user classifier 207 can be trained to predict the probability of a user churning. Churn is defined as the loss of customers or subscribers. The user classifier 207 uses the features extracted by the feature engineering component 203 to predict the probability of churn for each user. This information can be used to target users with customized promotions and other interventions to reduce churn based on the probability of churn of the user.

The user favorite channel identifier 209 can be trained to identify a user's favorite channel of type of program. This information can be used to deliver promotions to the user through their preferred channel or program. The user favorite channel identifier 209 uses the subset of the features extracted by the feature engineering component 203 to identify the user's favorite channel.

In an embodiment, the content storage system 122 can be any type of database, including a relational database, a NoSQL database, and a cloud database. The content storage system 122 can be structured in a way that allows the feature engineering component 203 to easily extract the relevant features. In addition to the user data 202 and account data 204 in separate tables.

The storage can store promotional messages 206 in addition to the user data 202 and the account data 204. The promotional messages 206 table can be in a variety of formats, such as text, images, or videos. The promotional messages 206 describe, illustrate, or depict promotions with values that are in an inverse relationship with probabilities of churn. For example, a probability of churn 80% can match a promotional message with a value of $500, while a probability of churn of 10% can match a promotional message of $100.

After predicting the probability of churn for a user and identifies the user's favorite channel or type of programs, the customized promotion delivery component 121 can select a promotion that matches the user's probability of churn and send a message with the selected the promotion via the user's favorite channel or type of programs.

As further shown in FIG. 2, three different promotional messages 139-143 are delivered to the different receiving devices 127-131 and then displayed on three different presentation devices 133-137. In an embodiment, the promotional messages 139-143 can be in different formats and displayed on different channels.

For example, message A 239 can be a short video message displayed on a smart phone screen of user A via Cable News Network (CNN), because CNN has been determined by the user favorite channel identifier 209 to be user A's favorite channel. In addition, message A 239 depicts a promotion package that is worth $500 because use A has been classified by the user classifier 207 to be a user with a 90% probability of churn. As another example, message B 241 can be a short video message displayed on a smart TV screen of user B via Fox News, because Fox News has been determined by the user favorite channel identifier 209 to be user B's favorite channel. In addition, message B 241 depicts a promotion package that is worth $333 because use B has been classified by the user classifier 207 to be a user with a 60% probability of churn. As a further example, message N 243 can be a short video message displayed on a desktop computer screen of user N via America TV Network (TNT), because TNT has been determined by the user favorite channel identifier 209 to be user N's favorite channel. In addition, message N 243 depicts a promotion package that is worth $166 because use N has been classified by the user classifier 207 to be a user with a 30% probability of churn.

It should be appreciated that the promotional messages 239-243 can also be delivered to their respective intended users via other means, such as multimedia messaging service (MMS) messages, emails, and traditional paper mails.

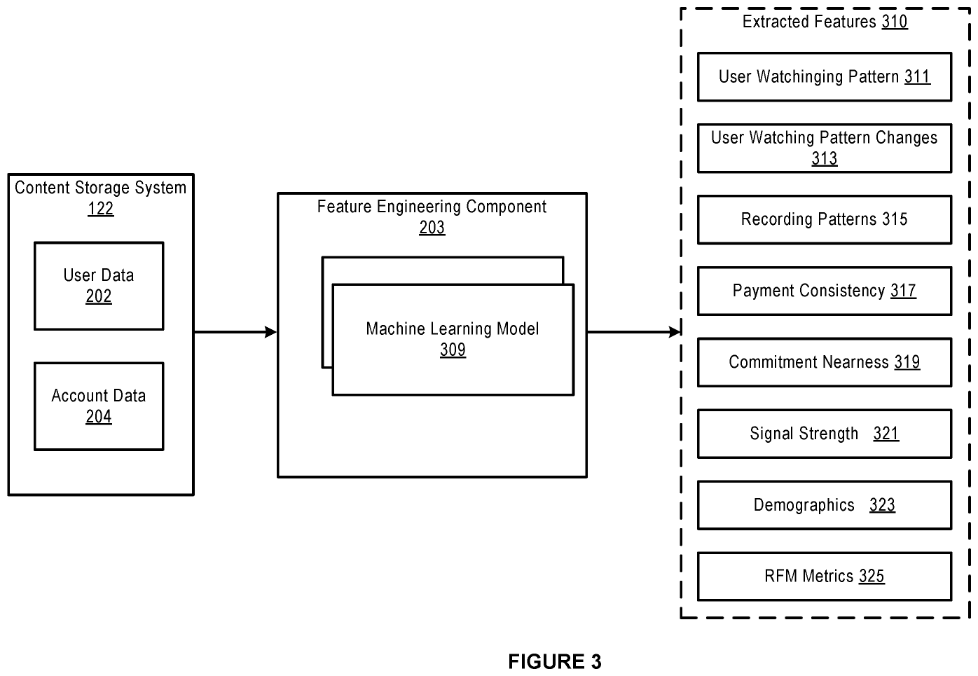

FIG. 3 is a block diagram further illustrating the feature engineering component 203 according to an embodiment of the disclosure. As shown, the feature engineering component 203 can include one or more machine learning models (e.g., machine learning model 309) for use in extracting features from timer-series user data 202 and account data 204. The user data 202 can include time-series data of all users, including their watching activities. The account data 204 includes all data related to user's account, including types of subscription plans for all users, and payment information.

As further shown, the extracted features 310 can include a user watching pattern 311, a user watching pattern changes 313, recording pattern 315, payment consistency 317, commitment nearness 319, signal strength 321, and RFM metrics 325. These features can be extracted by analyzing the user data and account data during the past period of time (e.g., 3 months) in accordance with an embodiment.

In an embodiment, the user watching pattern 311 refers to the average time per session in each month of the last period of time. The user watching pattern change 313 refers to any increase or decrease per session over the past period of time. The recording pattern 315 refers to how frequently a user records a program during the past period of time. A higher frequency of recording indicates that the user is more interested in the content and therefore is less likely to churn. The payment consistency 317 refers to how many times the user did not timely pay the monthly payment in the past period of time. The commitment nearness 319 refers to how soon the user's commitment period is to expire. The sooner, the more likely the user is to churn. The signal strength 321 refers to the average strength of satellite signal. The stronger the signal, the less likely that the user is to churn. The demographics 323 refers to age, gender, income level, education, ethnicity, and geographic location of the user. Each demographic group possesses its unique set of needs, preferences, and challenges, which in turn influence their loyalty to a service or product. The RFM metrics 325 stands for recency, frequency, and monetary value. In this disclosure, recency refers to the last time the user watched something on the TV platform; frequency refers to the frequency that user watched the content; and monetary value refers to the value of the subscription, any premium services or content the user has purchased, or ad revenue generated from that user if it's an ad-supported platform.

The features 310-225 are provided for illustrative purposes. Many other features can be extracted by the machine learning model 309, which can be a tree based learning model., such as that which uses a uses a distributed gradient-boosting framework for machine learning. For example, such models may use or include light gradient-boosting machine (LightGBM). As another example, such models may include or use Extreme Gradient Boosting (XGBoost). As another alternative non-limiting example, in alternative embodiments, machine learning model 309 may be a trained deep learning model, such as a recurrent neural network (RNN), a long short-term memory (LSTM) network, or a convolutional neural network (CNN).

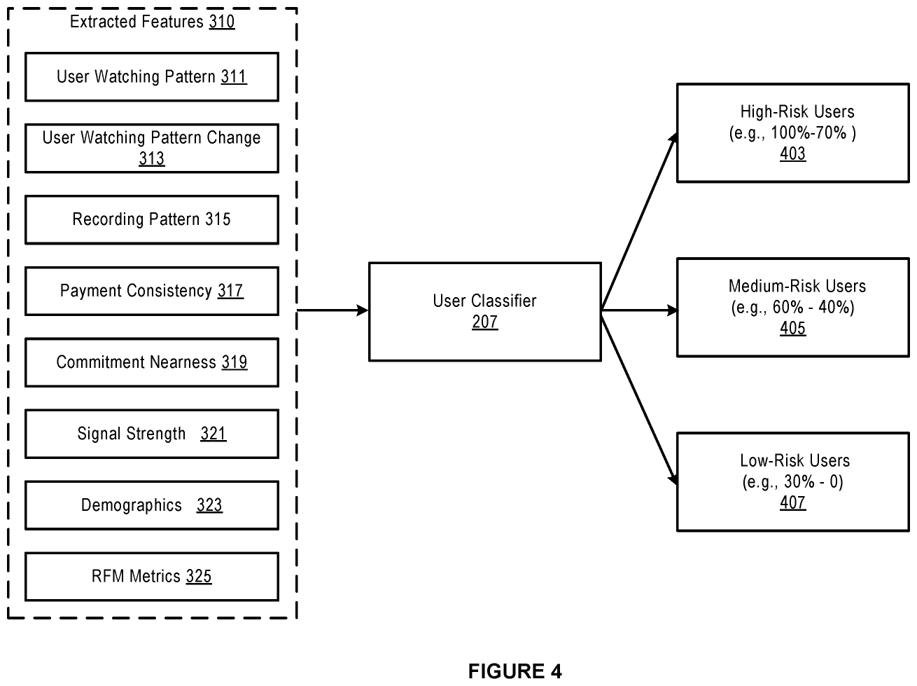

FIG. 4 is a block diagram further illustrating the user classifier 207 according to an embodiment of the disclosure. The user classifier 207 may be tree based learning model, such as that which uses a uses a distributed gradient-boosting framework for machine learning. For example, such models may use or include light gradient-boosting machine (LightGBM). As another example, such models may include or use Extreme Gradient Boosting (XGBoost). As another alternative non-limiting example, in alternative embodiments, the user classifier 207 may be a trained deep learning model, such as a CNN, RNN, or an LSTM.

In an embodiment, the user classifier 207 can be trained on training datasets that have been obtained from the content storage system 122 using the Synthetic Minority Over-sampling Technique (SMOTE). This technique is used to enhance the representation of churned users, as they are in the small minority (e.g., about 2-3% of all users). Without using SMOTE or similar sampling techniques, the training data may be imbalanced, potentially resulting in a model biased towards the majority class (i.e., unchurned users).

As shown, the extracted features 310 can be used as input features for the user classifier 207, which can generate an output value indicating a probability of churn. The user classifier 207 can generate a probability of churn for each user and thus put each user into one of the three groups based on their respective probability of churn: high-risk users 403, medium-risk users 405, and low-risk users 407. In another embodiment, the users can be classified into a high-risk group and a low-risk group based on their respective probabilities of churn. Users in the same risk groups can receive the same promotion package.

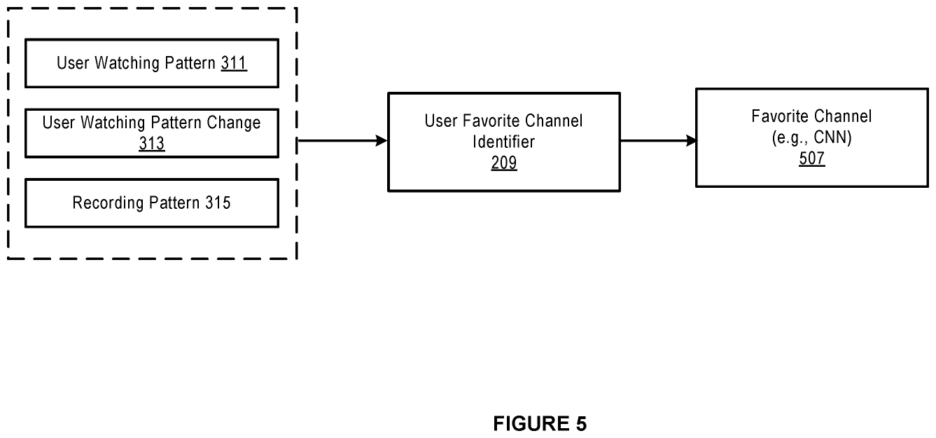

FIG. 5 is a block diagram further illustrating the user favorite channel identifier 209 according to an embodiment of the disclosure. The user favorite channel identifier 209 can be a machine learning model, which can be a tree based learning model that uses a distributed gradient-boosting framework for machine learning. As another alternative non-limiting example, in alternative embodiments user favorite channel identifier 209 may be a trained deep learning model, such as a recurrent neural network (RNN), a long short-term memory (LSTM) network, or a convolutional neural network (CNN).

As shown, the user favorite channel identifier 209 can determine a user's favorite channel 507 based on the user's watching pattern 311, watching pattern change 313, and recording pattern 315. The input features thus are a subset of the input features 310 for the user classifier 207 as described in FIG. 4.

In an embodiment, as used herein, a channel refers to a specific television or radio station that broadcasts a distinct set of programs. Channels can include a variety of content, such as news, sports, entertainment, movies, and more. Each channel is identified by a specific number and, often, a name or acronym representing the network or station (e.g., CNN, ESPN, HBO).

For each user, the user favorite channel identifier 209 can determine a favorite channel 507 based on the features 311, 313, and 315 related to the user. The favorite channel 507 can be used for receiving a customized promotional message for the group that the user has been classified into by the user classifier 207.

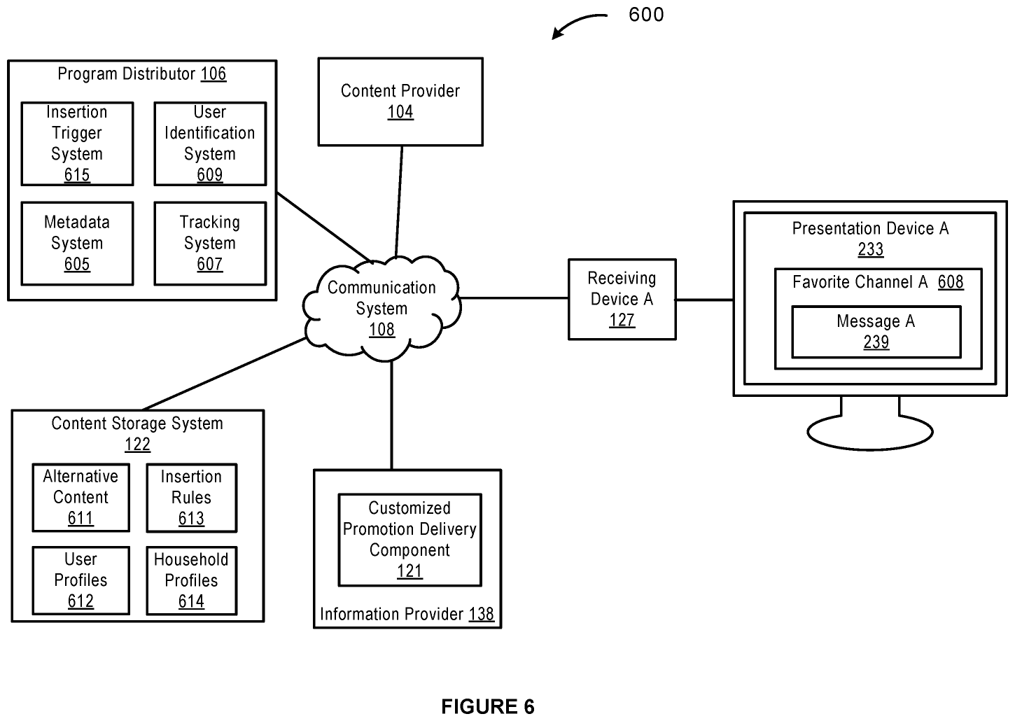

FIG. 6 is a block diagram illustrating a system 600 for delivering a targeted message to a presentation device 607 of a user via the user's favorite channel according to an embodiment of the disclosure. As previously described, the content provider 104 provides streams of television channels that include content items to the program distributor 106. The content provider 104 may have sold advertising space during commercial breaks. Therefore, the television channel streams received by the program distributor 106 can include television programs interspersed with commercials, each of which can be referred to individually as a content item. The system 600 can be used to replace commercials, television programs, or both.

The program distributor 106 can include a metadata system 605, a tracking system 607, a user identification system 609, and an insertion trigger system 615. These systems may be implemented using one or more processing systems that include one or more special-purpose or general-purpose processors. The content storage system 122 can further include a household profiles database 614, a user profiles database 612, an insertion rules database 613, and an alternative content database 611. Each of these databases may be stored using one or more non-transitory processor-readable mediums. The program distributor 106 may further include components to transmit television channel streams via a television distribution system, which can include a cable system, satellite system, IP-based system, or some other system that distributes television programming.

The program distributor 106 may insert metadata in each television channel stream prior to distributing or broadcasting. The metadata system 605 may analyze each received television channel stream from the content provider 104 and the information provider 138 and may insert metadata that identifies content items present within each television channel stream. For instance, each different content item present within each television channel stream may be assigned a unique identifier. Therefore, if the same content item appears on different channels, the same unique identifier may be associated with each instance of the content item. This metadata may be transmitted along with the television channel stream to various television receivers, such as the receiving device 127.

In an embodiment, the tracking system 607 may receive feedback from the receiving device 127 and use the feedback indicative of the particular content items that were output for presentation by the receiving device 120 to update the user profiles database 612 and household profiles database 614. The particular user profile and the particular household profile that are to be updated may be determined by the receiving device 127 or by the user identification system 609. The user identification system 609 may use data included in feedback to determine the particular user profile to be updated. The tracking system 607 can update the appropriate user profile and the household profile that is linked with the user profile in user profile databases 612 and the household profiles database 614, respectively.

In an embodiment, the insertion trigger system 615 may be used to determine when a content item in a television channel stream should be replaced with an alternative content item. The Insertion trigger system 615 may analyze data present in user profiles database 612, the household profiles database 614, the insertion rules database 613. The insertion rules database 613 may define particular rules for: 1) the circumstances for when a particular content item should be replaced; and 2) the qualifications for the alternative piece of content to replace the content item. For each content item that is eligible to be replaced, an entry may be present in insertion rules database 613. The entry may indicate, along with the unique identifier of the content item, a threshold number of times that the content item is to be output to a user prior to the content item being eligible for replacement. The entry may also indicate a threshold rate for a given time period that, when reached makes the content item eligible for replacement. The entry may also indicate the particular alternative content item that is to be substituted for the content item when one of the output thresholds for the content item has been reached. In some embodiments of the method, rather than a particular alternative content item being preselected for replacement of the content item, characteristics that are required to be present for alternative content items may be included instead.

By analyzing the viewership data present in household profiles database 614, the user profile database 612, and in combination with the insertion rules database 613, the insertion trigger system 615 can determine when a content item would be replaced with an alternative content item. An insertion trigger may be transmitted by the program distributor 106 to the receiving device 127 that indicates: an identifier of the content item to be replaced and an identifier of the alternative content item to insert in place of the content item. Upon receipt and processing of the insertion trigger, the receiving device 127 may begin monitoring for a next instance of the content item to be replaced based on the unique identifier of the content item being present in the metadata of television channel streams. When located, the receiving device 127 may insert the alternative content item in its place.

Therefore, using the above system 600, the information provider 138 can send information generated by the customized promotion delivery component 121 to the program distributor 106. The information sent by the information provider 138 to the program distributor 106 may include the favorite channel of each user and the promotion message that matches the group that the user has been classified into. The program distributor 106 may locate the favorite channel of each user and insert the promotion message to an appropriate place in a video stream associated with the favorite channel.

As shown in FIG. 6, message A 239 is a promotional message that has been determined to match the group, into which a user of the receiving device A has been classified using the user classifier 207. Favorite channel A 608 has been determined by the user favorite channel identifier 209 to be the user's favorite channel. Upon receiving the information from the information provider 138, the program distributor 106 can insert message A 239 to a video stream associated with favorite channel A 608.

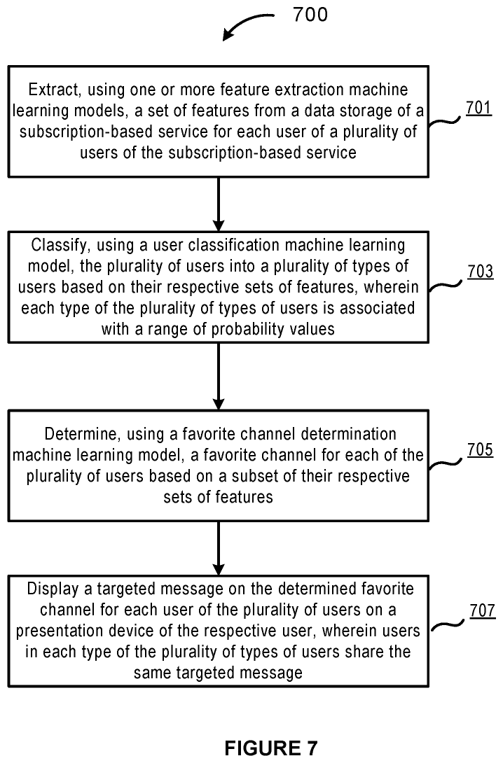

FIG. 7 is a block diagram illustration a process 700 of delivering targeted messages to users of a subscription-based service according to an embodiment of the disclosure. The process 700 can be performed by a processing logic that includes software, hardware, or a combination thereof. For example, the process 700 can be performed by the customized promotion delivery component 121 and the program distributor 106 illustrated in FIG. 1 and FIG. 2.

Referring to FIG. 7, at step 701, the processing logic extracts, using one or more feature extraction machine learning models, a set of features from a data storage of the subscription-based service for each user of a plurality of users of the subscription-based service.

At step 703, the processing logic classifies, using a user classification machine learning model, the plurality of users into a plurality of types of users based on their respective sets of features, wherein each type of the plurality of types of users is associated with a range of probability values.

At step 705, the processing logic determines, using a favorite channel determination machine learning model, a favorite channel for each of the plurality of users based on a subset of their respective sets of features.

At step 707, the processing logic displays a targeted message on the determined favorite channel for each user of the plurality of users on a presentation device of the respective user, wherein users in each type of the plurality of types of users share the same targeted message.

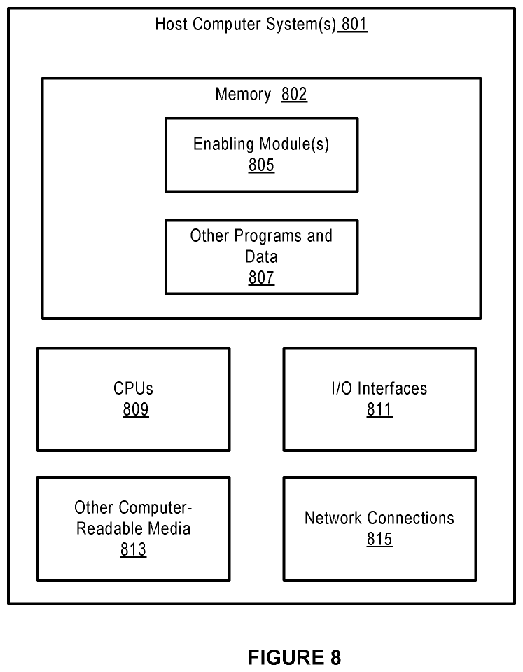

FIG. 8 shows a system diagram that describes an example implementation of a computing system(s) for implementing embodiments described herein.

The functionality described herein for delivering targeted messages to users at their favorite channels can be implemented either on dedicated hardware, as a software instance running on dedicated hardware, or as a virtualized function instantiated on an appropriate platform, e.g., a cloud infrastructure. In some embodiments of the method, such functionality can be completely software-based and is designed as cloud-native, meaning that they are agnostic to the underlying cloud infrastructure, allowing higher deployment agility and flexibility. However, FIG. 8 illustrates an example of underlying hardware on which such software and functionality can be hosted and/or implemented.

In this embodiment, an example host computer system(s) 801 is used to represent one or more of those in various components, servers, or nodes shown and/or described herein that are, or that host or implement the functions of: components, microservices, nodes, node groups, servers, virtual machines, and/or other aspects described herein. In some embodiments of the method, one or more special-purpose computing systems can be used to implement the functionality described herein. Accordingly, various embodiments described herein can be implemented in software, hardware, firmware, or in some combination thereof. Host computer system(s) 801 can include memory 802, one or more central processing units (CPUs) 809, I/O interfaces 811, other computer-readable media 813, and network connections 815.

Memory 802 can include one or more various types of non-volatile (non-transitory) and/or volatile (transitory) storage technologies. Examples of memory 802 can include, but are not limited to, flash memory, hard disk drives, optical drives, solid-state drives, various types of random-access memory (RAM), various types of read-only memory (ROM), neural networks, other computer-readable storage media (also referred to as processor-readable storage media), or the like, or any combination thereof. Memory 802 can be utilized to store information, including computer-readable instructions that are utilized by CPU 809 to perform actions, including those of embodiments described herein.

Memory 802 can have stored thereon enabling module(s) 805 that can be configured to implement and/or perform some or all of the functions of the systems, components and modules described. Memory 802 can also store other programs and data 807, which can include rules, databases, application programming interfaces (APIs), software containers, nodes, pods, clusters, node groups, software defined data centers (SDDCs), microservices, virtualized environments, software platforms, cloud computing service software, network management software, artificial intelligence (AI) or machine learning (ML) programs or models to perform the functionality described herein, user interfaces, operating systems, other network management functions, other NFs, etc.

Network connections 815 are configured to communicate with other computing devices to facilitate the functionality described herein. In various embodiments, the network connections 815 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 811 can include video interfaces, other data input or output interfaces, or the like. Other computer-readable media 813 can include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A method of delivering targeted messages to users of a subscription-based service, comprising:
extracting, using one or more feature extraction machine learning models, a set of features from a data storage of the subscription-based service for each user of a plurality of users of the subscription-based service;
classifying, using a user classification machine learning model, the plurality of users into a plurality of types of users based on their respective sets of features, wherein each type of the plurality of types of users is associated with a range of probability values;
determining, using a favorite channel determination machine learning model, a favorite channel for each of the plurality of users based on a subset of their respective sets of features; and
displaying a targeted message on the determined favorite channel for each user of the plurality of users on a presentation device of the respective user, wherein users in each type of the plurality of types of users share a same targeted message.

2. The method of claim 1, wherein the targeted message for each type of users is a promotional message with a promotional value that is inversely proportional to an upper limit of the associated range of probability values.

3. The method of claim 1, wherein the set of features for each of the plurality of users includes one or more of: a user watching pattern; user watching pattern changes; a recording pattern; payment consistency; commitment nearness; signal strength; demographics; or recency, frequency, money (RFM) data.

4. The method of claim 1, wherein the presentation device of the respective user is one of: a television, a personal computer, or a smart phone.

5. The method of claim 1, wherein the subset of features for each user of the plurality of users includes one or more of: a user watching pattern, user watching pattern changes, or a recording pattern.

6. The method of claim 1, wherein each of the one or more feature extraction machine learning models, the user classification machine learning model, and the favorite channel determination machine learning model is a tree based learning model.

7. The method of claim 6, wherein the user classification machine learning model is a tree based learning model that uses a distributed gradient-boosting framework for machine learning.

8. The method of claim 1, wherein the extracting of the set of features from the data storage of the subscription-based service for each user of a plurality of users is performed by a plurality of parallel processing nodes, wherein each of the one or more feature extraction machine learning models runs one of the plurality of parallel processing nodes.

9. A system, comprising:
one or more processors; and
one or more memories that are coupled to the one or more processors and storing program instructions for delivering targeted messages to users of a subscription-based service, which, when executed by the one or more processors, cause the system to perform operations comprising:
extracting, using one or more feature extraction machine learning models, a set of features from a data storage of a subscription-based service for each user of a plurality of users of the subscription-based service;
classifying, using a user classification machine learning model, the plurality of users into a plurality of types of users based on their respective sets of features, wherein each type of the plurality of types of users is associated with a range of probability values;
determining, using a favorite channel determination machine learning model, a favorite channel for each of the plurality of users based on a subset of their respective sets of features; and
displaying a targeted message on the determined favorite channel for each user of the plurality of users on a presentation device of the respective user, wherein users in each type of the plurality of types of users share a same targeted message.

10. The system of claim 9, wherein the target message for each type of users is a promotional message with a promotional value that is inversely proportional to an upper limit of the associated range of probability values.

11. The system of claim 9, wherein the set of features for each of the plurality of users includes one or more of: a user watching pattern; user watching pattern changes; a recording pattern; payment consistency; commitment nearness; signal strength; demographics; or recency, frequency, money (RFM) data.

12. The system of claim 9, wherein the presentation device of the respective user is one of: a television, a personal computer, or a smart phone.

13. The system of claim 9, wherein the subset of features for each user of the plurality of users includes one or more of: a user watching pattern, user watching pattern changes, or a recording pattern.

14. The system of claim 9, wherein each of the one or more feature extraction machine learning models, the user classification machine learning model, and the favorite channel determination machine learning model is a tree based learning model.

15. The system of claim 14, wherein the user classification machine learning model is a tree based learning model that uses a distributed gradient-boosting framework for machine learning.

16. The system of claim 9, wherein the extracting of the set of features from the data storage of the subscription-based service for each user of a plurality of users is performed by a plurality of parallel processing nodes, wherein each of the one or more feature extraction machine learning models runs one of the plurality of parallel processing nodes.

17. A non-transitory computer-readable storage medium storing program instructions for delivering targeted messages to users of a subscription-based service, wherein the program instructions, when executed by one or more processors, cause the one or more processors to perform operations comprising:
extracting, using one or more feature extraction machine learning models, a set of features from a data storage of a subscription-based service for each user of a plurality of users of the subscription-based service;
classifying, using a user classification machine learning model, the plurality of users into a plurality of types of users based on their respective sets of features, wherein each type of the plurality of types of users is associated with a range of probability values;
determining, using a favorite channel determination machine learning model, a favorite channel for each of the plurality of users based on a subset of their respective sets of features; and
displaying a targeted message on the determined favorite channel for each user of the plurality of users on a presentation device of the respective user, wherein users in each type of the plurality of types of users share a same targeted message.

18. The non-transitory computer-readable storage medium of claim 17, wherein the target message for each type of users is a promotional message with a promotional value that is inversely proportional to an upper limit of the associated range of probability values.

19. The non-transitory computer-readable storage medium of claim 17, wherein the set of features for each of the plurality of users includes one or more of: a user watching pattern; user watching pattern changes; a recording pattern; payment consistency; commitment nearness; signal strength; demographics; or recency, frequency, money (RFM) data.

20. The non-transitory computer-readable storage medium of claim 17, wherein the presentation device of the respective user is one of: a television, a personal computer, or a smart phone.
